(19) United States
(12) Patent Application Publication
(10) Pub. No.: US 2008/0040253 A1
(43) Pub. Date: Feb. 14, 2008

(54) System and method for creation and trade of exchange-backed equity investments

(76) Inventors: Eric C. Jacobson, Rockford, IL (US); Patrick J. Logue, Somers, NY (US)

Correspondence Address: GRAHAM S. JONES, II, 42 BARNARD AVENUE, POUGHKEEPSIE, NY, 12601-5023, US

(21) Appl. No.: 11/502,925

(22) Filed: Aug. 11, 2006

(51) Int. Cl. G06Q 40/00

(52) U.S. Cl. 705/37; 705/35

(57) ABSTRACT

Transactions are performed between owners of unique financial instruments, Digital Objects (DOs), issued by an exchange company. Owners of DOs are entitled equity in the exchange company where said equity is generated through operations related to the trade of said DOs. User terminals communicate with a computer system that manages all transactions of the DOs between DO owners. DOs are organized in DO Groups which contain subsets of DO Classes containing arrays of DOs. The amount of exchange company equity that is entitled to each DO is determined based upon the DO Class to which the DO belongs. Equity entitlement is allocated to a DO as a function of relative non-economic performance of an Independent Variable Feature (IVF), which could represent third-party entities, markets, events or conditions wherein the performance is not a function of economic performance of the exchange company. Each DO Class is linked to a particular IVF.

### BACKGROUND OF THE INVENTION

The present invention relates generally to electronic transactions relating to equity interests, and more particularly to interactive electronic transactions where the equity interests are associated with digital objects that are backed by equity.

World financial markets have long existed to allow individuals to trade objects of utility or monetary value. Early trading was very basic with traders exchanging goods of first hand value between each other, such as bread, tools, and clothing. A natural extension of the traditional exchange was developed in the form of trading objects of indirect value-objects that may be valuable to a market, but not necessarily valuable to an individual. This type of exchange can be in the form of grain, raw materials, etc. This spawned early commodities trading, where now economy-based supply and demand forces act on a centralized market. Essentially, markets transitioned from localized person to person trading, to decentralized region to region trading.

With the momentum of decentralized markets and indirect value trading, a new type of value object was in demand—the equity object. Digressing to the commodities market for a moment, the concept in grain trading is that owning grain can produce a monetary reward upon the sale of this grain to a merchant. As such, owning a futures contract for grain in effect ties the investor to a monetary value based on the market need for grain. The next logical extension would be to replace material market needs, such as grain, with more complex products or services. This is the foundation of equity trading. The idea that a company is monetarily rewarded by meeting certain market needs creates a scenario in which owning a part of that company can yield rewards in a similar fashion to grain, but on a slightly more complex level. From this idea, the common equity market was born. In an equity market, companies raise operating capital through the sale of fractional ownership in the form of shares in the company. Owners of the shares may then be entitled to a fractional stake in company profits as well as the ability to vote on key decisions within the company.

Common stocks representing fractional stakes in corporations are traded daily on securities exchanges such as the New York Stock Exchange, the London Stock Exchange, and the Deutsche Börse. The performance of stocks traded on those exchanges, to a large extent, is driven by financial results or speculation on the financial results of the companies publicly traded on their respective exchanges. Ultimately, the performance of the companies is driven by a demand for their products or services within one or multiple economies.

Investors take a risk when investing in the economic-driven performance of a corporation. As a result, the investor receives a potential for return on the initial investment. Risk-adverse investors demand more security than a potential return or payback on investment. This demand for diminished risk has been addressed through the legal entity of a corporation or, in other words, offering shares of a corporation to investors for a specified price. When an investor buys shares of a corporation, partial ownership of the corporation is bought that grants the investor limited voting rights on key corporate decisions and limited rights to assets of the corporation if the entity were to dissolve. Additionally, in some corporations, dividends are paid to investors.

Thus far, world markets have allowed traders to stake themselves in financial positions which are ultimately tied to the world economies. From the beginning to the end, such options and shares offer rewards based solely on the fundamental needs and demands of people, which drive economies. However, current and past markets do not allow for one to take a position in a non-economic based performance. The most logical explanation for this is that non-economic performance yields no direct revenue potential, so there is no direct way to provide financial reward to an owner of a ‘performance’ share. For example, if a quarterback makes a touchdown pass, that is good news for the sports fan, but it does not pay anything to the owner of a share or option in that type of non-economic performance. This begs the question as to whether there is a way to combine financial markets with sports or other non-economic performance entities in such a way that true equity can be granted whose monetary value changes as a function of non-economic performance.

A way to satisfy this market need would be the creation of a system where investors can collectively buy assets of value, and where the assets are distributed amongst investors based upon the performance of selected entities, markets, events, or conditions. For example, a group of investors could purchase a number of stocks. Additionally, each investor would choose certain sports teams of particular interest. Investor A might choose the Chicago Bulls and Investor B might choose the New York Knicks. Based upon the real-life performance of the Chicago Bulls and New York Knicks, the assets collectively purchased would be ratably allocated to each of the investors. Assets held by investors would fluctuate up or down based upon how well or how poorly their sports choice was performing. A similar model could be developed for other situations, including housing markets, weather conditions, elections, etc. Assets purchased and ratably distributed to investors could include stocks, mutual funds, houses, and gold, among other things, all of which are driven by several related economic factors.

This model provides a solution that allows investors to buy a position in entities, markets, events, or conditions that are not structured as publicly traded corporations. However, as this model is structured around assets that are not directly tied to the investment entities, markets, events or conditions of interest, the performance of the entity, market, event or condition is not isolated. The performance of a sports team could improve causing the percentage of equity allocated to investors in that team to increase; however, the assets backing the investment might fluctuate downwardly based upon completely unrelated external economic factors. Hence, despite the increased performance of the sports team, there would be a net decrease in the value of the investment. Fluctuation of the equity value is acceptable and expected as an external source of equity is being used, but the fluctuation would ideally not be based upon factors unrelated to the functioning of investment tool or the third-party entities therein. As the assets used to back the investment fluctuate as a function of external forces, this model creates an undesirably complicated investment tool.

There is a need for a system that provides investors with the security of equity investments while isolating the performance of certain entities, markets, events, or conditions. Such a system should provide a source of capital with which to reward people for this non-economic performance. As we have established, the performance itself is non-revenue generating, this capital will have to feed off the economy in some other way.

U.S. Pat. No. 6,119,229 of Martinez et al. for “Virtual property system” describes a digital object (DO) ownership system. The system includes user terminals and a central computer system for communicating with the user terminals. A plurality of Digital Objects (DOs) are provided, each of the DOs has a unique object identification code, and each DO is assigned to an owner. The DOs are persistent, in that each DO is accessible by a particular user whether or not the user terminal is in communication with the central computer system. The DOs have utility in connection with communication over a network in that the DO requires both the presence of the object identification code and proof of ownership.

U.S. Pat. No. 6,591,250 of Johnson et al. entitled “System and Method for Managing Virtual Property” describes a system and method for managing virtual property. Virtual items are each represented by one or more DOs and are managed by one or more computer systems functioning as an owner, broker, authenticator, and provider. Each virtual property unit can represent real-world items of value such as stocks, bonds, real-estate, etc.

U.S. Patent Application No. 2005/0080705 of Chaganti entitled “Selling Shares in Intangible Property Over the Internet” describes a method and system for the use of an electronic apparatus to issue, list, price and trade property interests in many forms of intangible property. The property includes patents, trademarks, copyrights, goodwill, licenses, leases, easements, rights, a seafaring route and others; personal rights, e.g. a right to future income of a person; special objects, e.g. collectibles; and services, e.g. time of a concert recital by a musician or time of a babysitter.

United States Patent Application No. 2005/0203818 of Rotman, et al. entitled “System and Method for Creating Tradeable Financial Units” describes an article suitable for trade as a unit in a financial offering by a company, representing in a predetermined ratio both equity and debt, while providing direct ownership of the equity and debt. The debt is interest bearing at a particular rate until a particular maturity date. An article suitable for trade as a unit in a subsequent offering further includes a second debt, which is interest bearing at the same rate until the maturity date of the first debt. A software reference can associate the equity and debt(s) of the unit to a unique number that is suitable for facilitating the clearing and settlement of purchases and sales. The unit provides direct ownership of the equity and debt without an intervening holding entity or the need for trust certificates and methods for establishing such units and for decomposing them.

In general, the aforementioned patents and patent publications describe systems or methods of creating and trading financial units with intrinsic value, or creating generalized DOs. Moreover, the above listed prior art does not describe a system or method whereby equity is distributed to investors based upon the performance entities, markets, events or conditions. Additionally, the above prior art does not describe a hierarchal structure for classification of DOs as they relate to unique entities, markets, events, or conditions.

U.S. Patent Application 2002/0077952 of Eckert et al. entitled “Method and Apparatus for Tradable Security Based on the Prospective Income of a Performer” describes a system for trading in a security having a value based on the prospective income of a performer. The system includes a first processor and a plurality of remote processors. The first processor receives and stores a plurality of bids for the purchase of one or more security instruments. Each security instrument has a value based on the prospective income of a performer and based at least in part on a contingent portion of the prospective income, the prospective income being service based. The plurality of remote processors is further adapted to be operable to communicate the plurality of bids to the first processor.

Eckert describes a system in which a performer (entertainer, athlete, or other) may sell contracts entitling owners of the contracts to a portion of the performer's income. Similarly to common commodities trading, this allows a performer to hedge his risk against potential losses in income. For an athlete, this may come in the form of an injury, or for an actor, this may come in the form of an underperforming movie release. While Eckert describes a modified futures market based on speculation around the income of a performer, it does not describe a market in which true equity in a corporation is allocated. Furthermore, Eckert does not provide for a method to allocate this income based on the performance of a set of related entities, markets, events, or conditions.

U.S. Pat. No. 7,031,938 of Fraivillig et al entitled “Funds Having Investment Results Related to Occurrence of External Events to Investor-Selected Investment Options” operates within the framework of an open-end mutual fund. It employs a system including instructions for causing investment returns for individual investors in the fund to correspond to occurrence of selected events with respect to investment options selected by the individual investors in the fund. The system defines several investment options each having a yield calculator. The calculator has a value related to occurrence of predefined events. The system selects a nominal yield of the fund and allocates a portion of the nominal yield to each investment option ratably with respect to the portion of the value of each the yield calculator bears to all values of the yield calculators. Periodically, the system calculates a change in total value of assets owned by the fund; ratably allocates the change to investors in the fund; and re-determines the values in each of the yield calculators by measuring occurrence of the predefined events during a selected measuring period.

With respect to sports teams, Fraivillig states “the playing performance of the investor-selected teams during a preselected period of time, such as the most recent calendar year, can be used to affect the investment results that an individual investor obtains from the mutual fund, as will be further explained.” In detail, with respect to sports leagues, Fraivillig describes a system for causing individual investor returns in a fund to correspond to occurrence of selected events relating to investment options selected by individual investors in the fund. The system comprises a computer having a program including instructions for: defining a plurality of said investment options, each having a yield calculator thereof having a value related to occurrence, to each said option, of predefined events, wherein said investment options comprise sports teams in a league and the predefined events comprise game wins; selecting a nominal yield of the fund, the nominal yield comprising a fixed value based on an expected return on assets of the fund; allocating a portion of the nominal yield to each of the investment options ratably with respect to the portion of the value of each the yield calculator bears to a total of all values of all of the yield calculators, the allocation made daily on a ratable basis to each investor in the fund; determining a per-share price for each of the investment options based on a relative ownership of each of the options; calculating, on a daily basis, a change in total value of the assets owned by the fund and ratably allocating the change to investors in the fund; and periodically redetermining the values in each of the yield calculators by measuring occurrence of the predefined events during a selected measuring period.

While the above prior art describes a method or a system of distributing investment yield to investors based upon the performance of entities, markets, events or conditions, it does not describe a system or method of isolating the performance of entities, markets, events or conditions from the fluctuating equity value of assets whose value is driven by external economies unrelated to the investment tool or third-parties therein. It would be desirable to have a self-contained market wherein value is determined solely by entity performance and/or factors related directly to the investment tool.

See U.S. Pat. No. 5,971,854 of Pearson et al. entitled “Interactive Contest System”; and U.S. Pat. No. 6,371,855 of Gavriloff entitled “Fantasy Internet Sports Game.”

### SUMMARY OF THE INVENTION

The present invention describes a tool that allows investment in the non-economic performance of entities, markets, events or conditions, but uses equity that is not influenced by external factors unrelated to the investment tool or third-parties therein. A company is established which allows investors to buy and sell a unique type of financial instruments which will be referred to as Digital Objects (“DOs” hereinafter) at prices driven by market supply and demand with real money.

DOs are unique financial instruments similar to common stock certificates (in digital form) with certain properties (e.g. unique identification number, unique owner, etc), including an association with an Independent Variable Feature (“IVF” hereinafter) that can be a single third-party entity (e.g. sports team), market (e.g. housing market), event (e.g. political election) or condition (e.g. weather). In addition to the IVF property, these DOs grant their owners equity ownership in the exchange corporation managing the trading of DOs. The amount of equity that a DO is entitled at any one time is a function of the IVF performance related to that DO, relative to other DOs being traded As such, it is possible to create a market of DOs representing non-monetary interest in third-party entities (“TPEs” hereafter), and have investors of these DOs receive an amount of equity ownership of the exchange corporation proportional to the performance of the TPE that said investor's DOs represent.

Equity value requires some form of revenue generation by the company managing the trade of DOs. In the case of an online exchange, both a trade commission can be administered by the company as a service charge for each trade and site advertisements can be a source of revenue. Additionally, corporate assets required to run the exchange (e.g. intellectual property, servers, etc) are counted as equity. As the equity is created by the assets of the exchange corporation, the value of the equity assigned to DOs does not fluctuate on unrelated external factors, but rather on factors directly related to the investment tool and TPEs therein.

With additional value fluctuations based on exchange company profitability, another dimension is added to investment tools, and a positive feedback scenario is created in the exchange. Trading volume generates more revenue for the exchange company which in turn creates more value for the shares, and therefore more demand. Another consequence is that an investor speculating on the popularity and profitability of the exchange company alone can purchase an index of all DO types causing the differences in performance of DO types to cancel each other out. In this scenario, the investor has effectively taken performance speculation out of his portfolio risk and now is tied solely to the profitability of the exchange company.

The invention and objects and features thereof will be more readily apparent from the following detailed description and appended claims when taken with the drawings.

### BRIEF DESCRIPTION OF THE DRAWINGS

The foregoing and other aspects and advantages of this invention are explained and described below with reference to the accompanying drawings, in which:

FIG. 1A shows a DO which is a unique object marked with a symbol in the upper left hand corner thereof representing a property such as a non-monetary association with an Independent Variable Feature (IVF).

FIG. 1B shows several DOs, etc., which are unique objects with properties such as non monetary association with Independent Variable Features (IVFs), which in this case are third-party entities, in the context of an internet-based exchange.

FIG. 2 illustrates the interrelationships within a DO Hierarchy between DOs, DO Classes, and DO Groups as they are associated and interconnected in an internet-based exchange.

FIG. 3A is a block diagram showing the linkage providing an interrelationship between a portion of the DO Hierarchy of FIG. 2 and an Exchange Company Structure in accordance with this invention.

FIG. 3B shows the relationship between one DO and one Quantity of Equity (Q/E) block in FIG. 3A which are linked by a linkage.

FIG. 4 shows additional details of the embodiment of FIG. 3A in which an Equity Allocation Method in accordance with one aspect of this invention is provided.

FIG. 5A shows an embodiment comprising a modification of the embodiment of FIG. 3A in which there are subsidiary companies to a parent company (exchange company) in a modified exchange company structure.

FIG. 5B also shows the linkage between a DO Array in a DO Hierarchy and an Exchange Company Structure on the right side of the FIG. 5A.

FIG. 6 illustrates an Equity Allocation Method in accordance with another one aspect of this invention which has been applied to the embodiment of FIG. 5A.

FIG. 7 illustrates how a DO is enhanced by the equity-backing process via a Q/E block which grants fractional ownership of the Exchange Company or a subsidiary thereof.

FIG. 8 is a chart illustrating an example of equity disbursement to DO Groups, DO Classes, and DO Arrays based on a single Exchange Company at a single point in time (the amount of equity disbursed to each DO constantly fluctuates).

FIG. 9 shows a central computer system (The Exchange) that allows for owners to buy and sell DOs with real money.

FIGS. 10A and 10B, in combination, show a flow chart describing the process flow for the exchange of equity-backed DOs.

FIGS. 11A and 11B in combination, show a flow chart describing steps in the process of systematic, constantly fluctuating equity allocation.

FIGS. 12 A and 12B illustrate how equity is allocated with actual numbers.

FIG. 12A illustrates sample calculations of equity allocation within a sports DO exchange.

FIG. 12B illustrates sample calculations of equity allocation within a housing market DO exchange.

### DESCRIPTION OF THE PREFERRED EMBODIMENTS

Digital Object (DO)

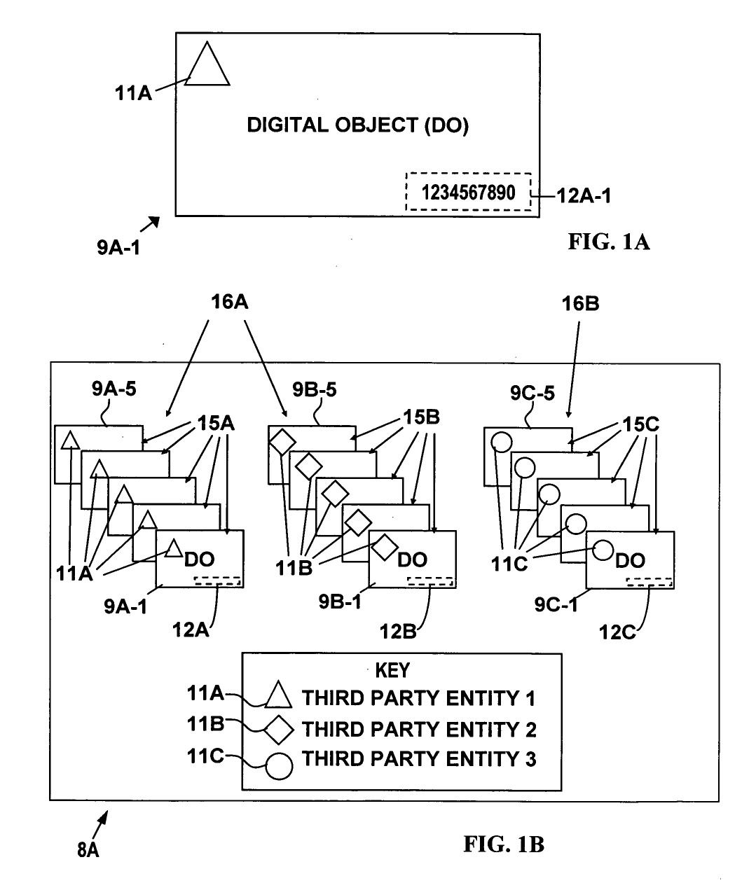

FIG. 1A shows a DO 9A-1 which is a unique DO marked with a symbol 11A in the upper left hand corner thereof representing a property such as a non-monetary association with an Independent Variable Feature (IVF) which could include a third-party entity (e.g. sports team), a market (e.g. housing market), an event (e.g. political election) or a condition (e.g. weather). The symbol 11A in the upper left hand corner of the DO 9A-1 is an Independent Variable Feature (IVF), which, in this case, comprises a third-party entity (“TPE” hereafter) such as a sports team. Each of the DOs is also marked with an indicium associated therewith which is one of a series of indicia such as a unique identification number “1234567890” or serial number in the block 12A-1 on the lower right hand corner.

Digital Object (DO) Hierarchy

FIG. 1B shows an example of a DO hierarchy 8A of DO Groups 16A and 16B, which include three sets of DO Classes 15A, 15B in Group 16A and DO Class 15C in DO Group 16B and subsets comprising several arrays of five DOs 9. The DO Class 15A includes an array of DOs 9A-1 to 9A-5. The DO Class 15B includes an array of DOs 9B-1 to 9B-5. The DO Class 15C includes an array of DOs 9C-1 to 9G-5. In other words, there are numerous DOs 9 included in one DO Group of three DC Classes 15A, 15B, and 15C, with an array of five DOs 9 in each DO Class 15. While each DO 9 is unique, several DOs 9 can have similar attributes to the attributes of other DOs, such as association with the same TPE 11 as shown by the symbols 11A, 11B, 11C in FIG. 1B. For convenience of illustration, reference indicia for the DO Arrays in DO Classes 15A, 15B, and 15C are provided solely for the first and last members 9A-1 and 9A-5, 9B-1 and 9B-5, and 9C-1 and 9C-5 of the three arrays of five DOs.

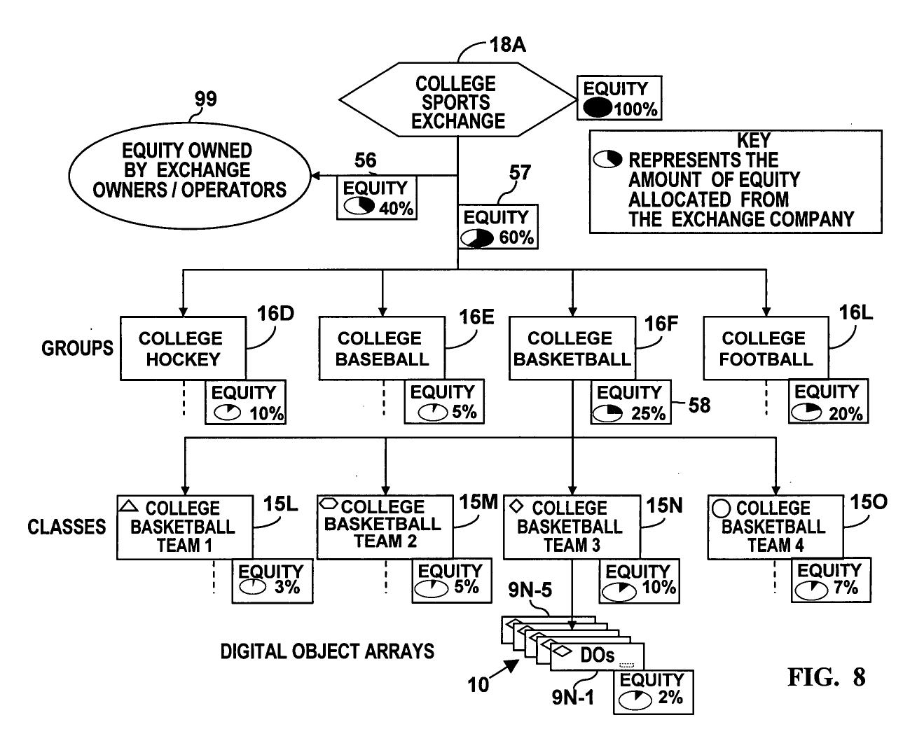

While each of the DOs 9 of a specific DO Class 15 is a unique object, as members of that DO Class 15, the DOs included therein have common properties, such as a non-monetary association with an IVF. In this case, the IVF is a TPE 11 which could be a sports team such as the New York Knicks or the Chicago Bulls or other sports teams as exemplified in FIG. 8 which is described below Table I describes the third-party entities in FIG. 1B.

TABLE I
THREE SYMBOLS FOR INDEPENDENT VARIABLE FEATURES,
IN THIS CASE THIRD PARTY ENTITIES (TPEs)

| CLASS SYMBOL | KEY | IVF |
|---|---|---|
| 11A | Triangle | THIRD PARTY ENTITY (TPE) 1 |
| 11B | Diamond | THIRD PARTY ENTITY (TPE) 2 |
| 11C | Circle | THIRD PARTY ENTITY (TPE) 3 |

Expanded DO Hierarchy

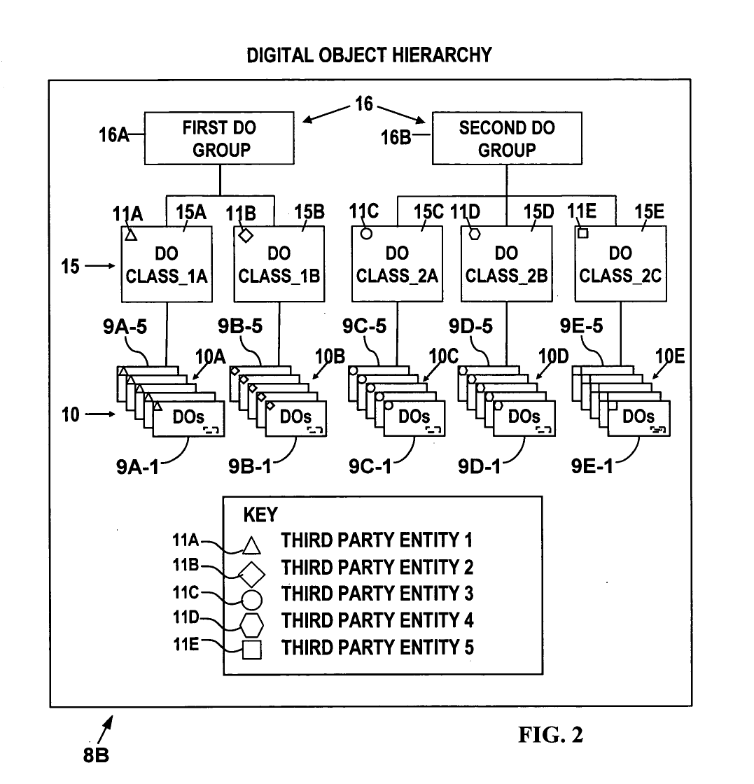

FIG. 2 shows the relationships within a DO Hierarchy 8B between DO Groups 16, DO Classes 15, and DO Arrays 10 as they are associated and interconnected in an internet-based exchange.

In particular, FIG. 2 shows two DO Groups 16A/16B with a total of five DO Classes 15A-15E included within the two combined DO Groups 16A/16B. The two DO Classes 15A and 15B are connected with and contained within the First DO Group 16A. The three DO Classes 15C, 15D and 15E are connected with and contained within the Second DO Group 16B. FIG. 2 also illustrates the relationship between five DO arrays 10A-10E included in the five DO Classes 15A-15E. Each one of the DO Classes 15A-15E includes a corresponding one of the five sets of DO Arrays 10A-10E. In FIG. 2 the structures of the First DO Group 16A and the Second DO Group 16B are shown. As will be explained below, the DO Groups 16, DO Classes 15 and the DO Arrays 10 are associated with other elements and are interconnected in an internet-based exchange.

In summary, the First DO Group 16A includes into two DO Classes 15A/15B each of which is subdivided into separate DO arrays 10A/10B based upon their common attributes. The Second DO Group 16B includes three DO Classes 15C/15D/15E which are each subdivided into the DO arrays 10C/10D/10E based upon their common attributes. In an internet-based exchange in accordance with this invention there can be an unlimited number of DO Groups 16, DO Classes 15, and DO Arrays 10.

Each DO Class 15 will contain at least two DOs 9, but all of the DOs 10 within a given DO Class 15 have the same association with a TPE 11. There can be an unlimited number of DOs 9 within each DO Class 15. Each individual DO Class 15 contains only those DOs 9 with the same TPE association. Each DO Class 15 can represent a sports team, and DOs 9 can comprise tradable shares representing interest in a specific sports team in a particular DO Class 15. Note that DO Groups 16 and DO Classes 15 are not tangible objects or legal entities, they are simply a mechanism for describing the organization of the DOs 9. Using sports as one example DO Groups 16 can represent sports leagues. For example, with reference to professional baseball the First DO Group could be the National League and the Second DO group could be the American League.

There can be an unlimited number of DO Groups 16, of DO Classes 15, and of DO Arrays 10. There can be an unlimited number of DO Classes 15 with in every DO Group 16 and a unique TPE 11 for each DO Class 15 within a DO Group 16.

TABLE II
EXPANDED TABLE OF SYMBOLS FOR INDEPENDENT
VARIABLE FEATURES (IVFs), IN THIS CASE
THIRD PARTY ENTITIES (TPEs)

| INDICIA | KEY | IVF |
|---|---|---|
| 11A | Triangle | THIRD PARTY ENTITY (TPE) 1 |
| 11B | Diamond | THIRD PARTY ENTITY (TPE) 2 |
| 11C | Circle | THIRD PARTY ENTITY (TPE) 3 |
| 11D | Hexagon | THIRD PARTY ENTITY (TPE) 4 |
| 11E | Square | THIRD PARTY ENTITY (TPE) 5 |

### First Embodiment

Linking of the Digital Object (DO) Hierarchy to an Equity Model to Create Value for Consumers

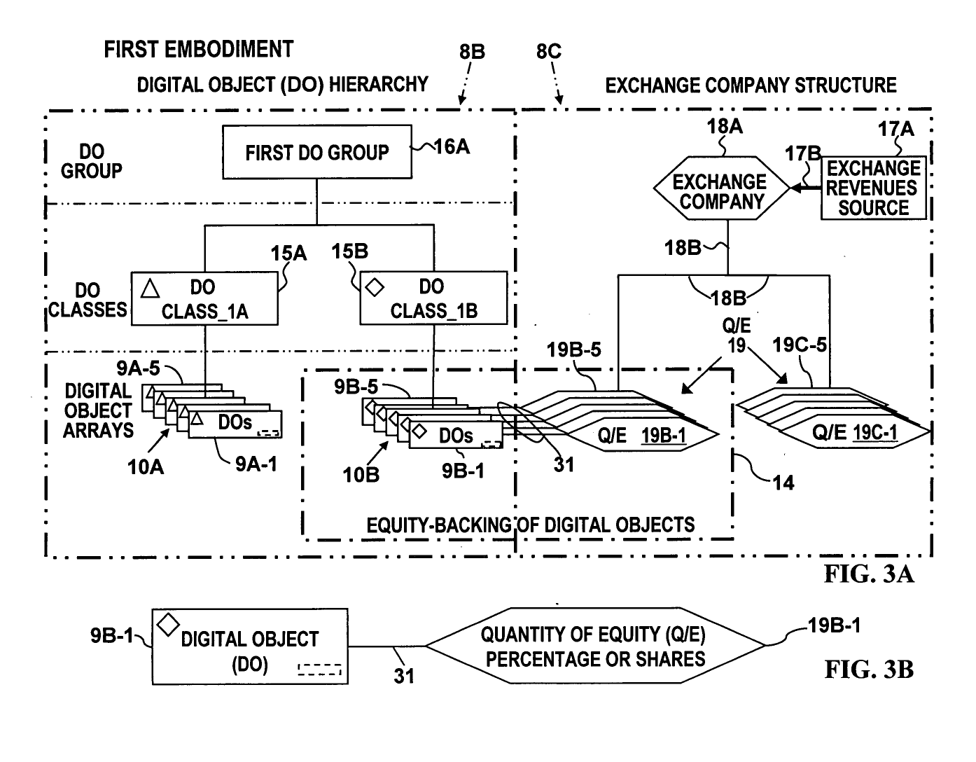

FIG. 3A is a block diagram showing the linkage providing an interrelationship between a portion 8B of the Digital Object (DO) Hierarchy 8A of FIG. 2 and an Exchange Company Structure 8C (shown only in FIG. 3A) in accordance with this invention.

On the left side of FIG. 3A is shown the portion 8B of the First DO Group 16A of the DO Hierarchy 8A of FIG. 2. The DO Class_1A 15A and the DO Class_1B 15B, as well as the DO Arrays 10A and 10B, are shown as they are shown in FIG. 2 and as they are described above.

The Exchange Company Structure 8C on the right side of FIG. 3A includes an exchange company 18A which performs the function of entitling the owner of each DO 9 in a DO Array 10 to obtain equity in the exchange company 18A based upon predetermined criteria (i.e. performance of TPEs). Each of a plurality of Q/E units exemplified by Q/E units 19B-1 to 19B-5 and Q/E units 19C-1 to 19C-5 represents a fractional ownership in the exchange company 18A, i.e. a percentage ownership in the case of an LLC or ownership of a share or shares in the case of a corporation. Each DO 9 in a DO Array 10 entitles the DO owner to an equity value based upon legal contracts in the operating contracts of the exchange company 18A, as well as other necessary legal contracts. Each DO owner is entitled to a certain portion of equity in the exchange company 18A. Each DO 9 in the same DO Class 15 is entitled to the same amount of equity as other DOs in DO Array 10. If a DO Class_1A 15A or DO Class_1B 15B represents 10% of the total exchange company equity, and there are 100 DOs in each Class_1A and Class_1B, each DO 10 in Class_1 entitles each owner of a DO 9 in the DO Class_1A 15A and DO Class_1B 15B to 0.1% ownership in the exchange company 18A. The exchange company 18A receives revenues on line 17B from exchange revenues source 17A which adds equity value to be combined with any pre-existing assets held by the exchange company 18A. The revenues received on line 17B include such revenues as trade commissions and site advertising.

FIG. 3A also shows the linkage between DO Array 10B (which includes the five DOs 9B-1 to 9B-5) in the Digital Object Hierarchy 8B and the Exchange Company Structure 8C on the right side of the FIG. 3A. That linkage is provided by an equity-backing block 14 which provides equity-backing of the several DOs 9B-1 to 9B-5 in the DO Array 10B. The exchange company 18A is connected via lines 18B to a pair of Quantity of Equity (Q/E) blocks 19, which are representative of a larger number of Q/E blocks 19 (not shown for convenience of illustration).

In particular, each of the DOs 9B-1 to 9B-5 is connected by a corresponding one of the linkages 31 to a set of Quantity of Equity (Q/E) blocks 19 which are indicative of the percentage of ownership or the number of shares of the individual DO 9 linked to the individual Q/E blocks 19B1-19B5.

FIG. 3B shows the relationship between one Digital Object (DO) 9B-1 and one Quantity of Equity (Q/E) block 19B-1 in FIG. 3A that are linked by one of the linkages 31.

Referring again to FIG. 3A, parallel to the Q/E blocks 19B-1 to 19B-5 are the Q/E blocks 19C-1 to 19C-5 which are provided for connection to another DO array 10 which is not shown and so the linkages corresponding to linkages 31 are not shown for convenience of illustration. In other words, FIG. 3A illustrates how the five individual DOs 9B-1 to 9B-5 in a DO Array 10B link via lines 31 to the corresponding five Quantity of Equity (Q/E) blocks 19B-1 to 19B-5. The equity-backing block 14 employs a model to create value for the consumer-owners of the DOs 9B-1 to 9B-5, or in other words describes the equity-backing, or the exchange-backing, of Digital Objects (DOs) 9.

Equity Allocation Model with a Single Exchange Company

Allocation of equity by the exchange company equity is controlled by two sets of key factors defined in TABLE III below. The factors in the first set comprise the Trading Volume Factors. The factors in the second set comprise the Independent Variable Feature (IVF) Performance Rating Values, which in this case are values which describe the performance of TPEs. The Trading Volume Factor F(V %_{CUX}) and an IVF Performance Rating F(TPE_{X}) are defined in TABLE III. The Trading Volume Factor determines how much of the exchange company equity is allocated to DOs 9 of a particular DO Group 16 based upon how much trading volume has occurred in the corresponding DO Group 16 relative to other DO Groups 16. The IVF Performance Rating determines the amount of Equity that is allocated to a particular DO Class 15, based upon the relative performance of the TPE 11 that is associated with that DO Class 15. Equity from the Exchange Company 18A is allocated to DOs 9 based upon a process involving a number of calculations 38.

TABLE III
Equity Allocation Variables

| | | |
|---|---|---|
| F(V %_{CUX}) | Trading Volume Factor | Percent of Equity Allocation |
| | | Based Upon Relative |
| | | Trading Volume of the DO |
| | | Arrays 10 Associated with |
| | | a Specified DO Group 16 |
| F(TPE_{X}) | IVF Performance Rating | Percent of Equity Allocation |
| | Value (Using a TPE | Based Upon Non-Economic |
| | for Illustration) | Performance of a Third Party |
| | | Entity Market, Event, or |
| | | Condition (Using a TPE in This |
| | | Case for Illustration) |

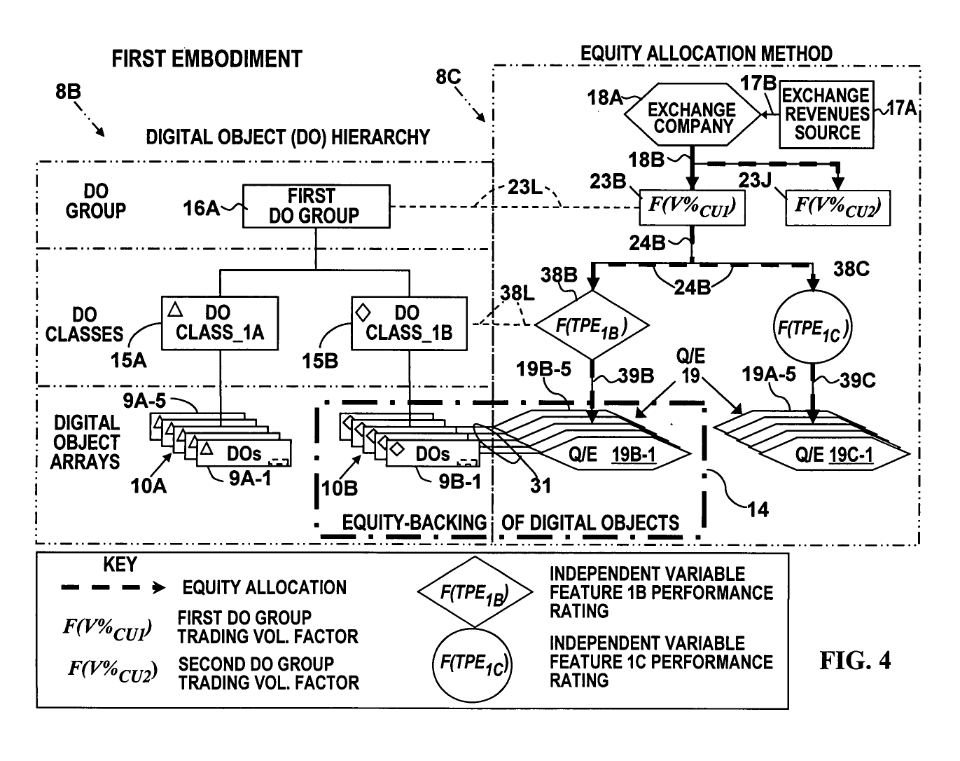

FIG. 4 illustrates an Equity Allocation Method in accordance with one aspect of this invention which has been applied to the embodiment of FIG. 3A.

In FIG. 4 the exchange company 18A is connected via lines 18B to a first Trading Volume Factor F(V %_{CU1}) block 23B and to a second Trading Volume Factor F(V %_{CU2}) block 23J. The block 23J is shown simply to illustrate the fact that line 18B is connected to two or more Trading Volume Factor blocks 23.

The block 23B provides a linkage via line 23L to the First DO Group 16A in accordance with a First DO Group Trading Volume Factor F(V %_{CU1}). In addition, the first Trading Volume Factor F(V %_{CU1}) block 23B is connected via line 24B to the IVF 1B Performance Rating F(TPE_{1B}0 block 38B and also via line 24B to the IVF 1C Performance Rating F(TPE_{1C}) block 38C. The latter block 38C is shown simply to illustrate the fact that line 24B is connected to two or more IVF Performance Rating blocks 38, the remainder of which are not shown for convenience of illustration.

The F(TPE_{1B}) block 38B provides a linkage via line 38L to the DO Class_1B block 15B in accordance with an F(TPE_{1B}) factor. The F(TPE_{1B}) block 38B is connected via line 39B to the Q/Es 19B-1 to 19B-5 to control the allocation of value to each of the DOs 9B-1 to 9B-5 in the DO Array 10B via lines 31 to the corresponding the Q/Es 19B-1 to 19B-5 through linkages 31.

The F(TPE_{1C}) block 38C is connected via line 39C to the Q/Es 19C-1 to 19C-5 to control the allocation of value to each of the DOs in a DO Array 10 (not shown for convenience of illustration) corresponding the Q/Es 19B-1 to 19B-5 through similar linkages to that DO Array 10.

The Trading Volume Factors 23 determine how much of the equity in the Exchange Company 18A is to be allocated to DOs 9 in a particular DO Group 16 based upon how much trading volume has occurred for the DO Group 16. As the trading volume of a first DO Group 16 increases relative to other DO Groups 16, equity allocated to the first DO Group increases, and equity allocated to other DO Groups 16 decreases accordingly.

The IVF Performance Rating Values 38 govern how much Equity is allocated to a DOs Class 15 associated with a particular TPE 11. As the IVF Performance Rating Value of one DO Class 15 increases, equity allocated to that DO Class 15 will increase, and equity allocated to other DO Classes 15 decreases accordingly.

Ultimately, the Trading Volume Factors 23 and the IVF Performance Ratings 38 govern how much of the equity in the exchange company 18A is granted to each DO 9.

### Second Embodiment

Use of Multiple Companies for Equity-Backing with a Modified Exchange Company Structure

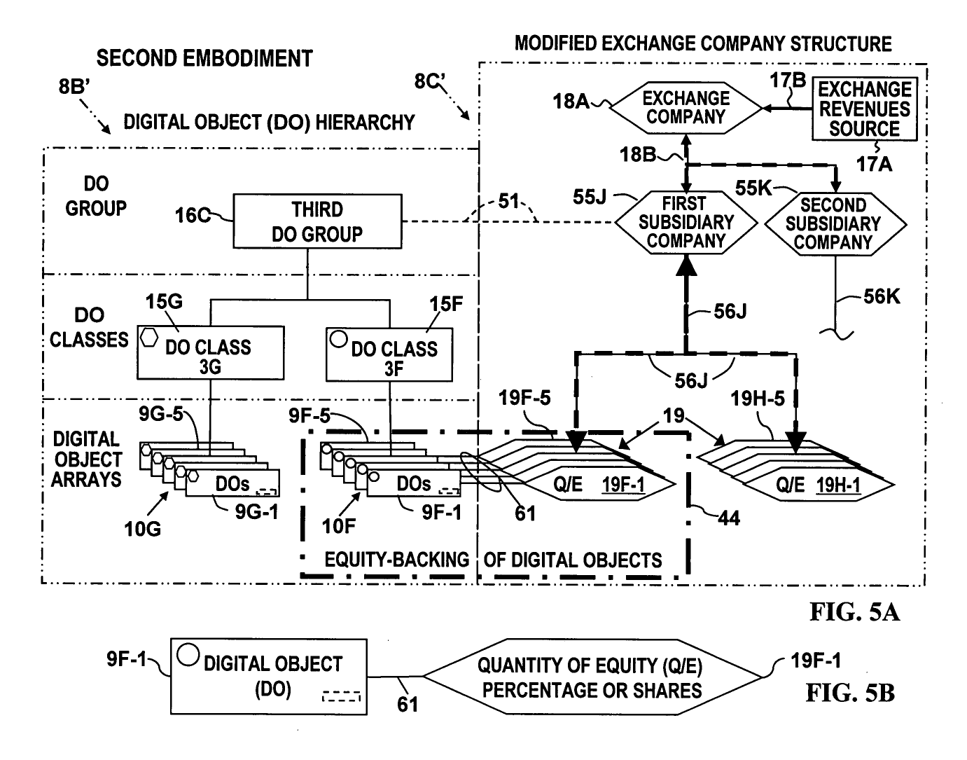

FIG. 5A shows an embodiment comprising a modification of the embodiment of FIG. 3A in which there are subsidiary companies 55J/55K to a parent company (exchange company 18A) in a modified exchange company structure 8C′. The modified exchange company structure 8C′ includes multiple subsidiary companies 55J, 55K (two or more) which mirror the DO Classes 15 and/or DO Groups 16 (not shown for convenience of illustration) other than DO Group 16C in the related portions of the modified Digital Object Hierarchy 8B′. Revenue flows from the exchange company 18A to the subsidiary companies 55J/55K thereby creating equity in each. The quantity of equity units assigned to the DOs 9 in the DO Group 16C is derived from the subsidiary companies 55J/55K. The subsidiary companies 55J/55K (which may be corporations) allow Equity Backing of DOs 9 in DO Group 16C and related DO Groups 16 (e.g. sports leagues, and the like.) Each subsidiary company 55J/55K receives revenue flows from the exchange company 18A (i.e. a parent company or corporation) thereby creating equity in the corresponding subsidiary company 55J/55K. The equity values of the Q/E units 19 are derived from the subsidiary companies 55J/55K. All DOs 9 from a particular DO Group 16 are backed by Q/E units from the related subsidiary company 55J/55K.

FIG. 5A also shows the linkage between DO Array 10F (which includes the five DOs 9F-1 to 9F-5) in the Digital Object Hierarchy 8B′ and the Exchange Company Structure 8C′ on the right side of the FIG. 5A. That linkage is provided by an equity-backing block 44 which provides equity-backing of the several DOs 9F-1 to 9F-5 in the DO Array 10F. In particular, each of the DOs 9F-1 to 9F-5 is connected by a corresponding one of the linkages 61 to a set of Quantity of Equity (Q/E) blocks 19 which are indicative of the percentage of ownership or the number of shares of the individual DO 9 linked to the individual Q/E blocks 19F. FIG. 5B shows the relationship between the Digital Object (DO) 9F-1 and the Quantity of Equity (Q/E) block 19F-1 which are linked by one of the linkages 61. Referring again to FIG. 5A, parallel to the Q/E blocks 19F-1 to 19F-5 are the Q/E blocks 19H-1 to 19H-5 which are provided for connection to another DO Array 10 (which is not shown for convenience of illustration and so the linkages corresponding to linkages 61 are not shown for convenience of illustration) In other words, FIG. 5A illustrates how the five individual DOs 9F-1 to 9F-5 in a DO Array 10F link via lines 61 to the corresponding five Quantity of Equity (Q/E) blocks 19F-1 to 19F-5. The equity-backing block 44 employs a model to create value for the consumer-owners of the DOs 9F-1 to 9F-5, or in other words describes the equity-backing of DOs 9F-1 to 9F-5 using the equity in subsidiary company 55J.

Equity Allocation Model with an Exchange Company and Multiple Subsidiaries

The Trading Volume Factors control how much equity is allocated to each Subsidiary Company based on how much trading volume is associated with each of said Subsidiary Companies. Each Subsidiary Company governs equity distribution to DOs 9 within a certain DO Group 16 (e.g. Sports League like College Basketball). The amount of equity that is distributed to the DOs 9 of a particular DO Class 15 is determined by the IVF Performance Rating to that DO Class 15.

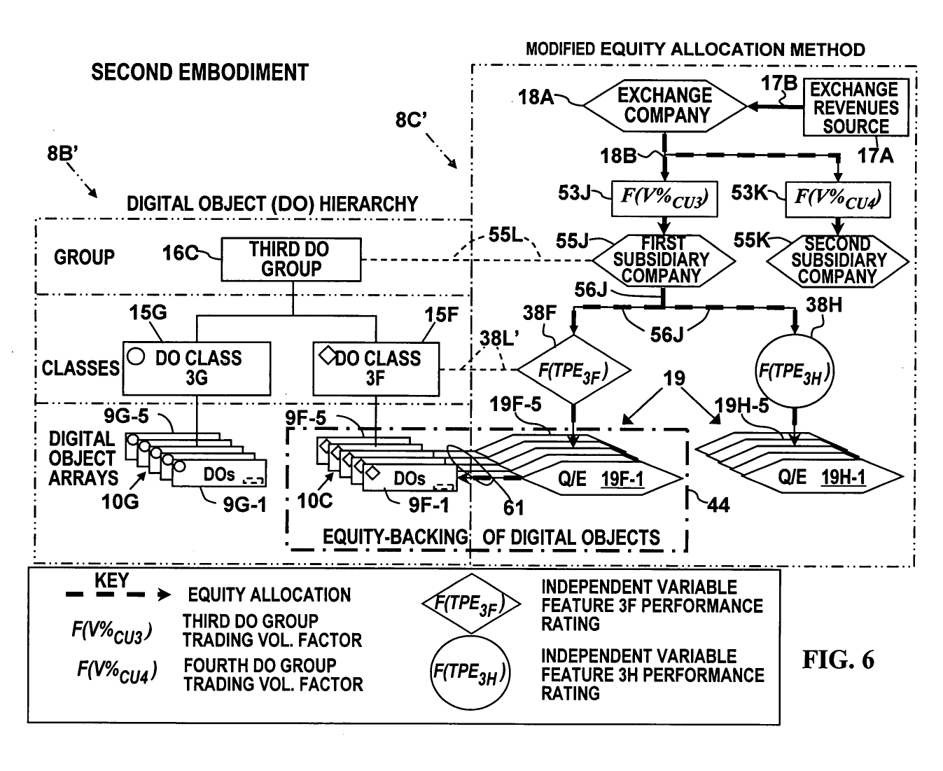

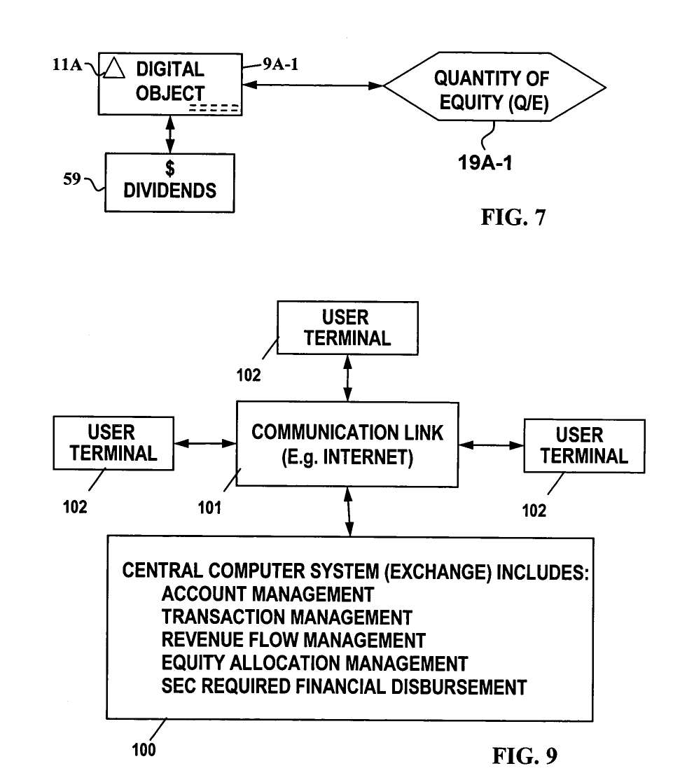

FIG. 6 illustrates an Equity Allocation Method in accordance with another one aspect of this invention which has been applied to the embodiment of FIG. 5A. In FIG. 6 the exchange company 18A is connected via lines 18B to a third Trading Volume Factor F(V %_{CU3}) block 53J and to a fourth Trading Volume Factor F(V %_{CU4}) block 53K. The block 53K is shown simply to illustrate the fact that line 18B is connected to two or more Trading Volume Factor blocks 53.

The Third Trading Volume Factor F(V %_{CU3}) block 53J connects to a subsidiary company 55J which provides a linkage via line 55L to the Third DO Group 16C with the value transmitted thereto being in accordance with the Third DO Group Trading Volume Factor F(V %_{CU3}). In addition, the Third Trading Volume Factor F(V %_{CU3}) block 53J connects to the input of the First Subsidiary Company 55J. The outputs of the First Subsidiary Company 55J connect via line 55L to the Third DO Group 16C and via line 56J to the IVF 3F Performance Rating F(TPE_{3F}) block 38F and also via line 56J to the IVF 3H Performance Rating F(TPE_{3H}) block 38H. The latter block 38H and the corresponding Q/Es 19H-1 to 19H-5 are shown simply to illustrate the fact that line 56J is connected to two or more IVF Performance Rating blocks 38 (not all of which are shown for convenience of illustration.)

The F(TPE_{3F}) block 38F provides a linkage via line 38L′ to the DO Class_3F block 15F in accordance with an F(TPE_{3F}) factor. The F(TPE_{3F}) block 38F is connected to the Q/Es 19F-1 to 19F-5 to control the allocation of value to each of the DOs 9F-1 to 9F-5 in the DO Array 10C via lines 61 to the corresponding the Q/Es 19F-1 to 19F-5 through linkages 61.

The F(TPE_{3H}) block 38H is connected to the Q/Es 19H-1 to 19H-5 to control the allocation of value to each of the DOs in a DO Array 10 (not shown for convenience of illustration) corresponding the Q/Es 19H-1 to 19H-5 through similar linkages to that DO Array 10 (not shown.)

The Trading Volume Factors 53 determine how much of the equity in the Exchange Company 18A is to be allocated to the respective subsidiary company 55J/55K and thereby the DOs 9 in a particular DO Group 16 based upon how much trading volume has occurred for that DO Group 16. As the trading volume of a first DO Group 16 increases relative to other DO Groups 16, equity allocated to the first DO Group 16 increases, and equity allocated to other DO Groups 16 decreases accordingly.

The IVF Performance Rating Values govern how much Equity is allocated to a DO Class 15 associated with a particular TPE 11. As the IVF Performance Rating Value of one DO Class 15 increases, equity allocated to that DO Class 15 will increase, and equity allocated to other DO Classes 15 decreases accordingly.

Ultimately, the Trading Volume Factors 53 and the TPE Performance Ratings 38 govern how much of the equity in the exchange company 18A is granted to each DO 9.

The Value of Exchange-Backed DOs for Consumers

limited legal ownership of the exchange company 18A;
certain legal rights to corporate assets if the exchange company were to dissolve; and
the possibility of some voting rights, pending decision of the exchange operators.

Example of Equity Disbursement

FIG. 8 is a chart illustrating an example of equity disbursement to DO Groups 16, DO Classes 15, and DOs 9 based on a single Exchange Company 18A at a single point in time (the amount of equity disbursed to each DO constantly fluctuates).

Enablers of the Digital Object Exchange

FIG. 9 shows a central computer system 100 (The Exchange) that allows for owners to buy and sell DOs 9 with real money. Owners of DOs 9 are able to connect via the internet 101 to the exchange computer system 100 via user terminals 102 (e.g. personal computers w/internet access). This central computer system 100 facilitates the trading of DOs 9, tracks ownership of DOs 9 and allows owners to manage their accounts (add funds, remove funds, collect dividends, etc). Moreover, the central computer system 100 exercises a commission on each trade made by a DO owner which is counted as revenue for the exchange company 18A in FIG. 8.

Allocation of Equity to DO Groups, Classes and DOs

Referring again to FIG. 8, there are DO Groups 16 which include a College Hockey DO Group 16D, a College Baseball DO Group 16E, a College Basketball League DO Group 16F, and a College Football DO Group 16L. In the College Basketball League DO Group 16F there are College Basketball Teams including Team 1 DO Group 15L, Team 2 DO Group 15M, Team 3 DO Group 15N, and Team 4 DO Group 15O. In the Team 3 DO Group 15N there is a group 10N of DOs 9N-1 to 9N-5.

In FIG. 8, the Exchange Company 18A (College Sports Exchange in this case) has a 100% equity balance, which is derived from all the Exchange's assets including commission revenues and advertising sales. A certain percentage 56 of Equity (e.g. 40%) is allocated to the Exchange Company owners and operators 99. Another certain percentage 57 of Equity (e.g. 60%) is allocated to be disbursed to DOs 9 in the exchange system. The Trading Volume Factor is used to determine the amount of Equity (e.g. 25%) that goes to the DO Group 16E (College Basketball League) The IVF Performance Rating Value is used to determine the amount of equity allocated to the College Basketball Team 3 (DO Class.) The equity allocated to the College Basketball Team is equally divided to each DO 9 within its DO Class 15.

Process Flow for the Exchange of Exchange-Backed Digital Objects

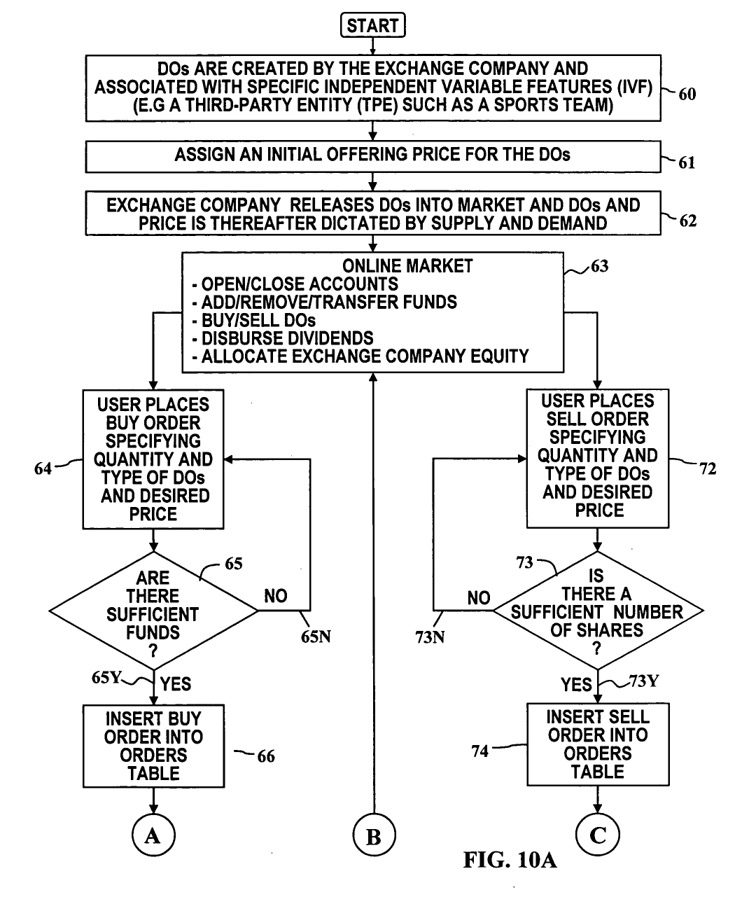

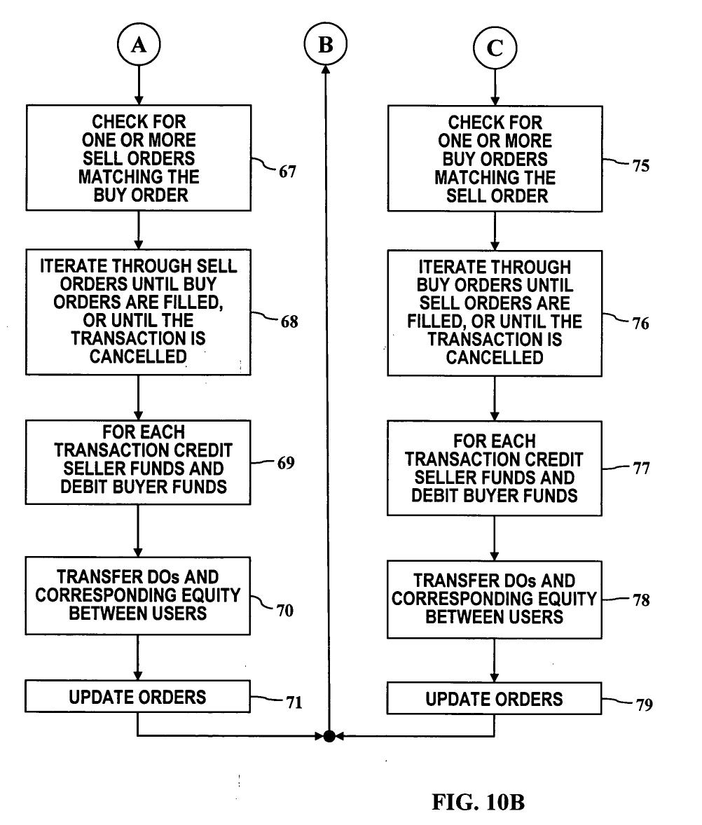

FIGS. 10A and 10B, in combination, show a flow chart describing the process flow for the exchange of equity-backed Digital Objects (DOs) 9.

In step 60, the exchange company 18A creates Digital Objects (DOs) 9 with each of the DOs 9 being associated with an appropriate specific Independent Variable Feature (IVF), e.g. a TPE 11 such as a sports team associated with the DO Class 15.

In step 61 the central computer system 100 (the exchange) assigns an initial offering price to each/all of the DOs 9 through a valuation process that could be driven by user demand such as a Dutch Auction.

In step 62 the exchange company 18A releases DOs 9 into the market for customer acquisition. At this point prices of DOs are driven solely by investor supply and demand.

In step 63 the central computer system 100 operates an online market which functions to perform the tasks as follows:
open/close accounts for users;
add funds to user accounts/remove funds from user accounts/transfer other funds; buy DO's for users and sell DO's for users;
allocate exchange company equity to users; and
disburse dividends to users.

In step 64 a user places a DO buy order via a user terminal 102 and a communication link 101 with the central computer system 100 specifying the quantity and the type of DO's 9 and the desired price.

In step 65 the central computer system 100 determines whether there are sufficient funds for purchasing the DOs ordered in the account of the user who has placed the DO buy order.

If the result of the test in step 65 is YES the central computer system 100 accepts the buy order and then proceeds to step 66 to process the accepted DO buy order; but if the result of the test in step 65 is NO, the program returns to step 64 to request the user change the quantity and or price of the order, or cancel the order.

In step 66 the central computer system 100 inserts the current DO buy order for which there are sufficient funds into the orders table in the central computer system 100.

The connector A at the bottom of FIG. 10A connects from block 66 to the block 67 at the top of FIG. 10B.

In step 67 the central computer system 100 checks for one or more pending DO sell orders matching an accepted DO buy order.

In step 68 the central computer system 100 iterates through pending DO sell orders until all accepted DO buy orders are filled, or the buy order is cancelled.

In step 69, for each transaction the central computer system 100 credits seller funds and debits buyer funds.

In step 70 the central computer system 100 transfers DOs and corresponding equity between users who participated in the transactions just completed.

In step 71 the central computer system 100 updates pending accepted DO buy orders.

In step 72 a user places a DO sell order via a user terminal 102 and a communication link 101 with the central computer system 100 specifying the quantity and the type of DOs to be sold and the desired price.

In step 73 the central computer system 100 performs a test to determine whether there is a sufficient number of shares in the seller's account.

If the result of the test in step 73 is YES the program the computer system 100 accepts the sell order and then proceeds to step 74 to process the accepted DO sell order; but if the result of the test in step 65 is NO, the program returns to step 72 to request the user changes the quantity of shares to sell, or cancel the order.

In step 74 the current accepted DO sell order for which there is a sufficient number of shares is inserted into the DO orders table in the central computer system 100.

The connector C at the bottom of FIG. 10A connects from block 74 to the block 75 at the top of FIG. 10B.

In step 75 the central computer system 100 checks for one or more DO buy orders matching the current accepted DO sell order.

In step 76 the central computer system 100 iterates through pending DO buy orders until all accepted DO sell orders are filled.

In step 77 for each transaction the central computer system 100 credits DO seller funds and debits DO buyer funds.

In step 78 the central computer system 100 transfer DOs and corresponding equity between users who participated in the transactions just completed.

In step 79 the central computer system 100 updates pending accepted sell orders.

Systematic Method of Constantly Fluctuating Equity Allocation

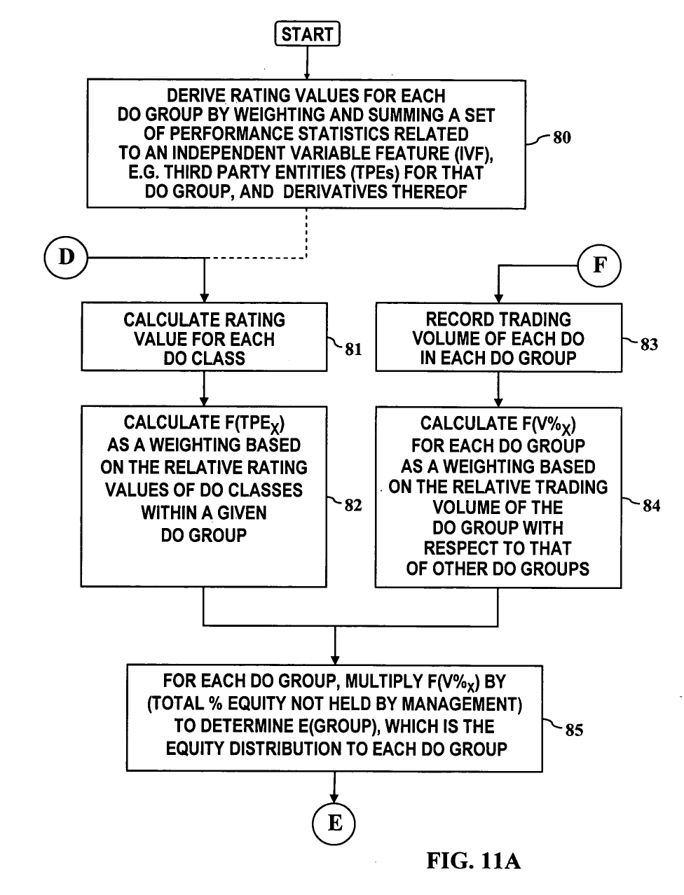

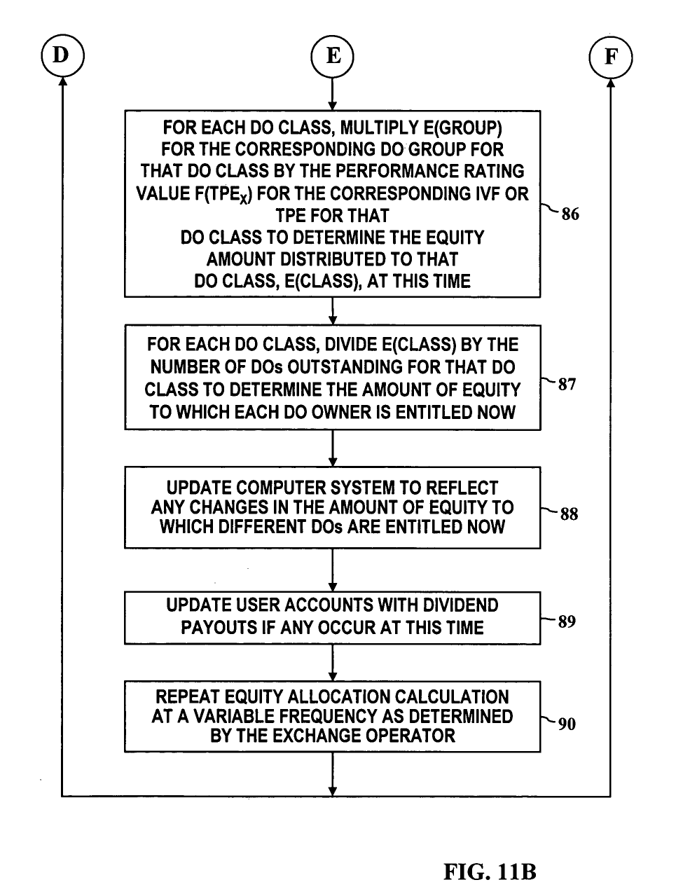

FIGS. 11A and 11B in combination, show a flow chart describing steps in the process of systematic, constantly fluctuating equity allocation.

Because the IVF Performance Rating Values F(TPE_{X}) and Trading Volume Factors F(V %_{CUX}) change with time, equity allocation to DOs 9 must be updated frequently by the computer system 100 shown in FIG. 9.

In step 80 in FIG. 11A, the computer system 100 derives rating values for each DO Group 16 by weighting and summing a set of performance statistics related to an Independent Variable Feature (IVF), e.g. Third-Party Entities (TPEs) for that DO Group 16, and derivatives thereof.

In step 81 the computer system 100 calculates the F(TPE_{X}) rating value for each DO Class 15 at a variable time interval.

In step 82 the computer system 100 calculates the F(TPE_{X}) as a weighting based on the relative rating values of DO Classes 15 within a given DO Group 16.

In step 83 the computer system 100 records trading volume of DOs in each DO Group 16 at a variable time interval.

In step 84 the computer system 100 calculates F(V %_{CUX}) for each DO Group 16 as a weighting based on the relative trading volume of the DO Group with respect to that of other DO Groups 16.

In step 85 for each DO group 16, the computer system 100 multiplies the Trading Volume Factors F(V %_{CUX}) by (total % equity not held by management) to determine E(Group), which is the equity distribution to each DO Group 16.

In step 86 for each DO Class, the computer system 100 multiplies the E(Group) value for the corresponding DO Group 16 for that DO Class 15 by the performance rating value F(TPE_{X}) for the corresponding IVF or TPE for that DO Class 15 to determine the equity amount distributed to that DO class, E(Class), at this time (currently).

In step 87 for each DO Class 9, the computer system 100 divides the E(Class) value by the number of DOs outstanding for that DO Class 9 to determine the amount of equity to which each DO owner is entitled now, i.e. currently.

In step 88 update the computer system 100 to reflect any changes in the amount of equity to which different DOs 9 are entitled now, i.e. currently.

In step 89 the computer system 100 updates user accounts with dividend payouts if any occur at this time.

In step 90, the equity allocation calculation is repeated at a variable frequency as determined by the exchange operator.

Sample Calculations of Equity Allocation

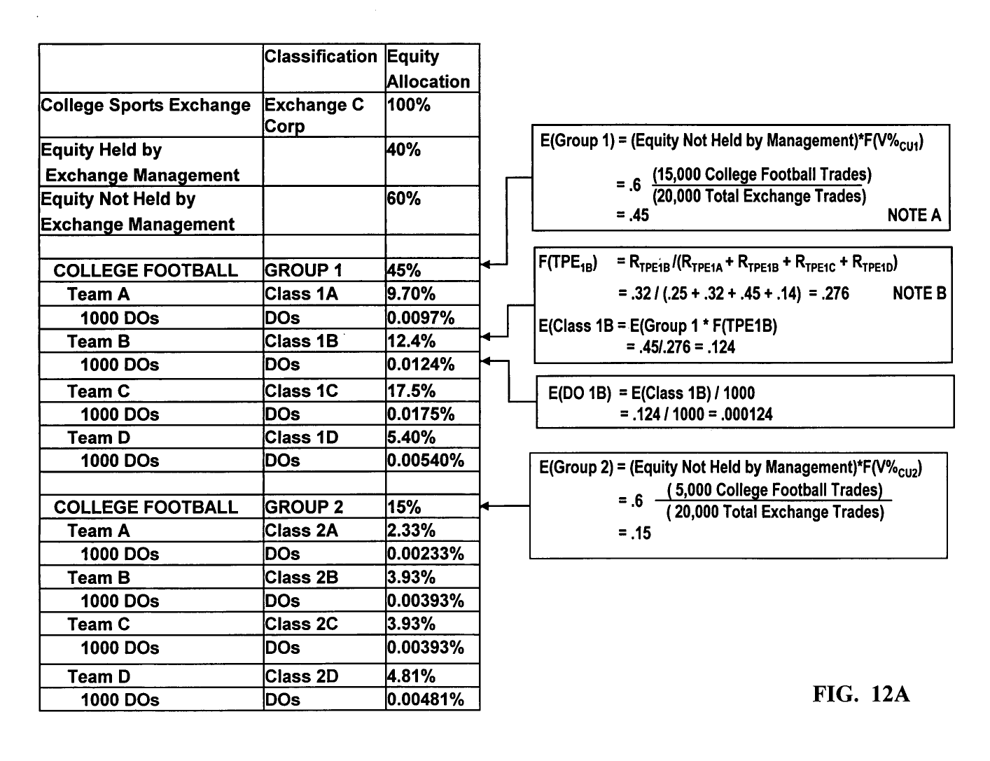

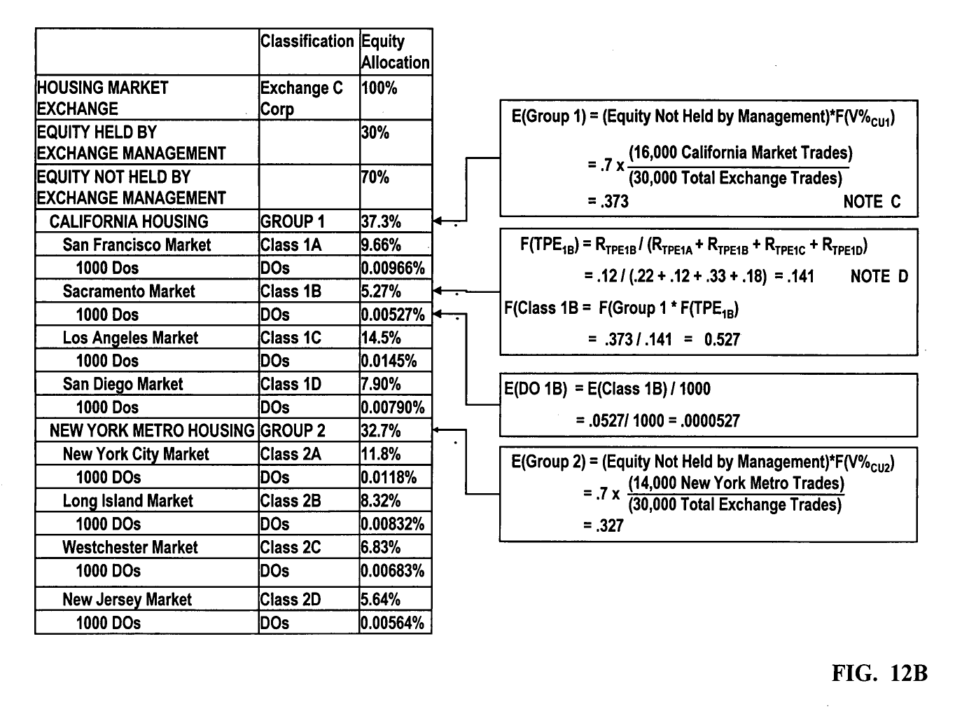

FIGS. 12A and 12B illustrate how equity could be allocated this point with actual numbers.

FIG. 12A illustrates equity allocation within a sports exchange context.

NOTE A for FIG. 12A is that it is assumed that there have been a total of 20,000 total exchange trades over the past time period, and that 15,000 of those trades were for college football, whereas 5,000 were for college basketball.

NOTE B for FIG. 12A is that F (TPE_{1B}) is by definition a Performance Rating Value that weights the TPE 1B against other DO Classes 1 within its DO Group 1. R_{TPE1B} is a Third-Party Entity Performance Rating Statistic for Team B of Group 1. This statistic can be obtained from any number of statistics including offensive or defense performance ratings.

FIG. 12B. illustrates equity allocation within a housing market exchange context.

Note C for FIG. 12B is that the assumption is that there have been a total of 30,000 total exchange trades over the past time period, and that 16,000 of those trades were for the California Market, whereas 14,000 were for the New York Metro market.

Note D: for FIG. 12B is that F(TPE_{1B}) is by definition a statistic that weights the TPE 1B against other Classes within its Group. R_{TPE1B} is a Third-Party Entity Performance Rating Statistic for Team B of Group 1. This statistic can be obtained from any number of statistics including number of houses sold in the last period or the average appreciation value of the market.

While this invention has been described in terms of the above specific embodiment(s), those skilled in the art will recognize that the invention can be practiced with modifications within the spirit and scope of the appended claims, i.e. that changes can be made in form and detail, without departing from the spirit and scope of the invention. Accordingly all such changes come within the purview of the present invention and the invention encompasses the subject matter of the following claims.

Having thus described the invention, what is claimed as new and desirable to be secured by Letters Patent is as follows:

1. A system for performing transactions between owners of equity-backed financial instruments, Digital Objects (“DOs”), each of which is associated with one of a plurality of independent variables, wherein a DO owner of a said DO is entitled to equity in an exchange company that facilitates both exchange and management of DOs, comprising:
A) a plurality of user terminals;
B) each of said user terminals being adapted for communication with a computer system associated with said exchange company to manage trading transactions as well as communicating with others of said user terminals;
C) a said computer system completing each sale and each purchase of said equity-backed DOs issued by said exchange company upon satisfaction of specified transaction conditions;
D) a plurality of DOs that entitle DO owners to a corresponding equity holding in said exchange company where equity value in said exchange company is generated through operations related to exchange of said DOs by said exchange company;
E) an organizational hierarchy for DOs consisting of at least one DO Group; a set of DO Classes within said DO Group; and each of said DO Classes containing a subset of unique, equity-backed DOs that can be traded as determined by said exchange company, wherein:
i) equity of said exchange company is allocated to DOs based upon a said DO Class in which said DO comprises a subset;
ii) a difference in equity entitlement is allocated to each said DO offered by different ones of said DO Classes as a function of relative performance of one of a set of related independent variable features (IVFs), each of said IVFs being uniquely linked to a said DO Class; wherein said relative performance is not a function of economic performance of said exchange company; and
iii) measurement of said relative performance of each of said IVFs is based on computer calculation in accordance with a predefined relative performance algorithm, unique to a said DO Group.

2. A system in accordance with claim 1 including calculating a trading volume factor F(V %_{CUX}) for each DO Group X.

3. A system in accordance with claim 1 including calculating a performance rating value F(IVF_{X}) for each DO Class X wherein an F(IVF_{X}) can be calculated for a measure selected from the group consisting of a Third-Party Entity (TPE), a market, an event, and a condition.

4. A system in accordance with claim 1 including calculating E(GROUP) by multiplying a trading volume factor F(V %_{CUX}) by a sum comprising total exchange company equity to be granted to investors.

5. A system in accordance with claim 4 including multiplying E(GROUP) for a corresponding DO Group by a performance rating value F(IVF_{X}) to determine an equity amount to be distributed to said given DO Class, E(CLASS).

6. A system in accordance with claim 5 including dividing E(CLASS) of said given DO Class as a numerator by a sum of DOs outstanding for said given DO Class as a denominator.

7. A system in accordance with claim 1 including calculating a performance rating value F(IVF_{X}) for each DO Class X by
i) weighting and summing a set of performance statistics related to each IVF in consideration to obtain R_{IVFX}; and
ii) weighting R_{IVFX} with respect to other R_{IVF} statistic values within a Group to determine said F(IVF_{X}) for DO Class X.

8. A system in accordance with claim 1 including operating an online market for said DOs.

9. A system for the purchasing, selling, and/or exchanging of equity-backed financial instruments, Digital Objects (DOs), between owners, wherein each of said DOs which is associated with one of a plurality of Independent Variable Features (IVFs) and each of said DOs entitles the owner thereof to an equity interest in an exchange company that facilitates both exchange and management of DOs, comprising:
A) a plurality of user terminals adapted to be connected to one or more satellite computers, each of said user terminals being accessible by one or more individual owners of an equity interest in said exchange company;
B) at least one central computer system adapted for real-time communication with a user terminal to manage trading transactions as well as communicating with other user terminals;
C) said computer system being adapted to complete each sale and each purchase of equity-backed DOs issued by said exchange company upon satisfaction of specified transaction conditions;
D) a plurality of DOs that entitle DO owner to a corresponding equity holding in said exchange company or any subsidiary of said exchange company where equity value in said exchange company is generated through operations related to exchange of said DOs by said exchange company;
E) an organizational hierarchy for DOs consisting of a number of DO Groups which have sets of DO Classes, wherein each DO Class contains a subset of unique, equity-backed DOs that can be traded as determined by said exchange company, wherein:
i. equity of said exchange company or any subsidiary of said exchange company is allocated to DOs based upon a said DO class to which said DO belongs;
ii. a difference in equity entitlement is allocated to each said DO offered by different ones of said DO Classes as a function of relative performance of one of a set of related independent variable features (IVFs), each of said IVFs being uniquely linked to a said DO class; wherein said relative performance is not a function of economic performance of said exchange company; and
iii. measurement of said performance of each IVF is based on a predefined algorithm performed by calculation by said computer system.

10. A system in accordance with claim 9 including calculating a trading volume factor F(V %_{CUX}) for each DO Group X.

11. A system in accordance with claim 9 including calculating a performance rating value F(IVF_{X}) for each DO Class X wherein an F(IVF_{X}) can be calculated for a measure selected from the group consisting of a Third-Party Entity (TPE), a market, an event, and a condition.

12. A system in accordance with claim 9 including calculating E(GROUP) by multiplying a trading volume factor F(V %_{CUX}) by the total exchange company equity to be granted to investors.

13. A system in accordance with claim 12 including multiplying E(GROUP) for a corresponding DO Group for a given DO Class by a performance rating value F(IVF_{X}) to determine the equity amount to be distributed to said given DO Class, E(CLASS).

14. A system in accordance with claim 13 including dividing E(CLASS) of said given DO Class as a numerator by a sum of DOs outstanding for said given DO Class as a denominator.

15. A system in accordance with claim 9 including calculating a performance rating value F(IVF_{X}) for each DO Class X by
i) weighting and summing a set of performance statistics related to each IVF in consideration to obtain R_{IFX}; and
ii) weighting R_{IVFX} with respect to other R_{IVF} statistic values within a Group to determine the F(IVF_{X}) for DO Class X.

16. A method for performing transactions between owners of equity-backed financial instruments, Digital Objects (DOs), each of which is associated with one of a plurality of independent variables, wherein a DO owner of a said DO is entitled to equity in said exchange company that facilitates both exchange and management of said DOs, comprising:
A) providing access for user terminals to communicate with a computer system associated with said exchange company to manage trading transactions as well as communicating with others of said user terminals;
B) providing for said computer system to complete each sale and each purchase of equity-backed DOs issued by said exchange company upon satisfaction of specified transaction conditions;
C) a plurality of DOs that entitle DO owners to a corresponding equity holding in said exchange company where equity in said exchange company is generated through operations related to exchange of said DOs by said exchange company;
D) an organizational hierarchy for DOs consisting of at least one DO Group; a set of DO Classes within said DO Group; and each of said DO Classes containing a subset of unique, equity-backed DOs that can be traded as determined by said exchange company;
i) equity of said exchange company is allocated to DOs based upon the DO Class in which said DO comprises a subset;
ii) a difference in equity entitlement is allocated to each said DO offered by different ones of said DO Classes of as a function of relative performance of one of a set of related Independent Variable Features (IVFs), each of said IVFs being uniquely linked to a said DO Class; wherein said relative performance is not a function of economic performance of said exchange company; and
iii) measurement of said relative performance of each of said IVFs is based on computer calculation in accordance with a predefined relative performance algorithm.

17. The method of claim 16 including calculating a trading volume factor F(V %_{CUX}) for each DO Group X.

18. The method of claim 16 including calculating a performance rating value F(IVF_{X}) for each DO Class X.

19. The method of claim 16 including calculating a trading volume factor F(V %_{CUX}) for each DO Group X.

20. The method of claim 16 including calculating a performance rating value F(IVF_{X}) for each DO Class X wherein an F(IVF_{X}) can be calculated for a measure selected from the group consisting of a Third-Party Entity (TPE), a market, an event, and a condition
